(19) United States
(12) Patent Application Publication
(10) Pub. No.: US 2025/0199663 A1
(43) Pub. Date: Jun. 19, 2025

(54) DATA ANALYSIS METHOD AND APPARATUS, COMPUTER DEVICE, AND STORAGE MEDIUM

(71) Applicant: DOUYIN VISION CO., LTD., Beijing (CN)

(72) Inventors: Miao Chen, Beijing (CN); Shuisheng Zhang, Beijing (CN); Danchi Fan, Beijing (CN); Yuan Zhang, Beijing (CN)

(21) Appl. No.: 18/985,637

(22) Filed: Dec. 18, 2024

(30) Foreign Application Priority Data
Dec. 19, 2023 (CN) 202311753170.2

(51) Int. Cl. G06F 3/0484; G06F 3/0482; G06F 16/34

(52) U.S. Cl. CPC G06F 3/0484; G06F 3/0482; G06F 16/345

(57) ABSTRACT

The present disclosure relates to the field of data visualization technologies, and discloses a data analysis method and apparatus, a computer device, and a storage medium. The present disclosure provides a data analysis method, including: displaying a data analysis page, where the data analysis page includes a data analysis control; obtaining a data analysis statement based on interaction with the data analysis control, and displaying the data analysis statement on the data analysis page; and displaying a message card representing an attribution result on the data analysis page based on the data analysis statement, where the message card includes a data display area and an analysis result display area, the data display area is configured to display to-be-attributed data corresponding to the data analysis statement, and the analysis result display area is configured to display attribution result details corresponding to the to-be-attributed data.

### CROSS-REFERENCE TO RELATED APPLICATION

This application claims priority to Chinese Application No. 202311753170.2 filed Dec. 19, 2023, the disclosure of which is incorporated herein by reference in its entirety.

### FIELD

The present disclosure relates to the field of data visualization technologies, and specifically to a data analysis method and an apparatus, a computer device, and a storage medium.

### BACKGROUND

Attribution analysis is one of the key steps in data analysis. Through attribution analysis, a main influence factor of to-be-attributed data can be identified, thereby helping make a reasonable decision and optimization on the extracted data.

However, in practical applications, since a user does not have the capability of writing a data analysis language, when attribution analysis needs to be performed on the to-be-attributed data, the user needs to rely on a related technician to obtain the data, thereby affecting working efficiency.

### SUMMARY

In view of the above, the present disclosure provides a data analysis method and an apparatus, a computer device, and a storage medium.

In a first aspect, the present disclosure provides a data analysis method, comprising:
displaying a data analysis page, where the data analysis page includes a data analysis control;
obtaining a data analysis statement based on interaction with the data analysis control, and displaying the data analysis statement on the data analysis page; and
displaying a message card representing an attribution result on the data analysis page based on the data analysis statement, where the message card includes a data display area and an analysis result display area, the data display area is configured to display to-be-attributed data corresponding to the data analysis statement, and the analysis result display area is configured to display attribution result details corresponding to the to-be-attributed data.

In a second aspect, the present disclosure provides a data analysis apparatus, including:
a first display module, configured to display a data analysis page, where the data analysis page includes a data analysis control;
an obtaining module, configured to obtain a data analysis statement based on interaction with the data analysis control, and display the data analysis statement on the data analysis page; and
a second display module, configured to display a message card representing an attribution result on the data analysis page based on the data analysis statement, where the message card includes a data display area and an analysis result display area, the data display area is configured to display to-be-attributed data corresponding to the data analysis statement, and the analysis result display area is configured to display attribution result details corresponding to the to-be-attributed data.

In a third aspect, the present disclosure provides a computer device, including: a memory and a processor, where the memory and the processor are communicatively connected to each other, the memory stores computer instructions, and the processor executes the computer instructions, thereby performing the data analysis method according to the first aspect or any implementation corresponding to the first aspect.

In a fourth aspect, the present disclosure provides a computer-readable storage medium, where the computer-readable storage medium stores a computer instruction, and the computer instruction is used to cause a computer to perform the data analysis method according to the first aspect or any implementation corresponding to the first aspect.

The data analysis method provided in the present disclosure can directly perform attribution analysis using a data analysis statement obtained from a data analysis page, and display an attribution result through a message card, so that a user can perform attribution analysis on to-be-attributed data more conveniently and more intelligently, thereby helping improve working efficiency of the user in attribution analysis.

### BRIEF DESCRIPTION OF THE DRAWINGS

In order to more clearly describe a specific implementation of the present disclosure or technical solutions in the prior art, the following briefly introduces the accompanying drawings required for describing the specific implementation or the prior art. Apparently, the accompanying drawings in the following description show some implementations of the present disclosure. For a person of ordinary skill in the art, other drawings may be obtained based on these accompanying drawings without creative efforts.

FIG. 1 is a schematic flowchart of a data analysis method according to an embodiment of the present disclosure;

FIG. 2 is a schematic diagram of an interface of a data display area according to an embodiment of the present disclosure;

FIG. 3 is a schematic diagram of an interface of an analysis result display area according to an embodiment of the present disclosure;

FIG. 4 is a schematic diagram of an interface of another analysis result display area according to an embodiment of the present disclosure;

FIG. 5 is a schematic diagram of an interface of yet another analysis result display area according to an embodiment of the present disclosure;

FIG. 6 is a schematic diagram of an interface of still another analysis result display area according to an embodiment of the present disclosure;

FIG. 7 is a schematic diagram of an interface of a dimension display area according to an embodiment of the present disclosure;

FIG. 8 is a schematic diagram of an interface of a result details area according to an embodiment of the present disclosure;

FIG. 9 is a schematic diagram of an interface of another result details area according to an embodiment of the present disclosure;

FIG. 10 is a schematic flowchart of another data analysis method according to an embodiment of the present disclosure;

FIG. 11 is a schematic diagram of an interface of still another analysis result display area according to an embodiment of the present disclosure;

FIG. 12 is a schematic diagram of an interface of a data analysis page according to an embodiment of the present disclosure;

FIG. 13 is a schematic diagram of an interface of an attribute details page according to an embodiment of the present disclosure;

FIG. 14 is a block diagram of a structure of a data analysis apparatus according to an embodiment of the present disclosure; and

FIG. 15 is a schematic diagram of a hardware structure of a computer device according to an embodiment of the present disclosure.

### DETAILED DESCRIPTION OF EMBODIMENTS

To make the objectives, technical solutions, and advantages of the embodiments of the present disclosure clearer, the technical solutions in the embodiments of the present disclosure are described clearly and completely below with reference to the accompanying drawings in the embodiments of the present disclosure. Apparently, the described embodiments are some, but not all, embodiments of the present disclosure. All other embodiments obtained by a person of ordinary skill in the art based on the embodiments of the present disclosure without creative efforts shall fall within the protection scope of the present disclosure.

In the related art, a tool for performing attribution analysis on data requires a user to have a certain analysis capability and is highly professional. However, if the user does not have the capability of using the tool and needs to analyze to-be-attributed data, the user needs to rely on a related technician to obtain the data. If the related technician is not available currently, the working efficiency of the user in attribution analysis is affected.

In view of this, an embodiment of the present disclosure provides a data analysis method, including: displaying a data analysis page, so that a data analysis statement to be subjected to attribution analysis can be obtained and displayed through the data analysis statement in the data analysis page. Based on the obtained data analysis statement, a message card representing an attribution result is displayed on the data analysis page, so that a user can quickly and intuitively view the attribution result through the message card, so that a manner of performing attribution analysis on to-be-attributed data is more convenient and more intelligent, which helps improve the working efficiency of the user. The message card includes: the message card includes a data display area and an analysis result display area, the data display area is configured to display to-be-attributed data corresponding to the data analysis statement, and the analysis result display area is configured to display attribution result details corresponding to the to-be-attributed data, so that the user can quickly know the to-be-attributed data involved in the attribution result and the corresponding attribution result details through the message card.

According to an embodiment of the present disclosure, an embodiment of a data analysis method is provided. It should be noted that the steps shown in the flowcharts of the accompanying drawings may be performed in a computer system such as a set of computer-executable instructions, and although a logical order is shown in the flowcharts, the steps shown or described may be performed in an order different from that herein in some cases.

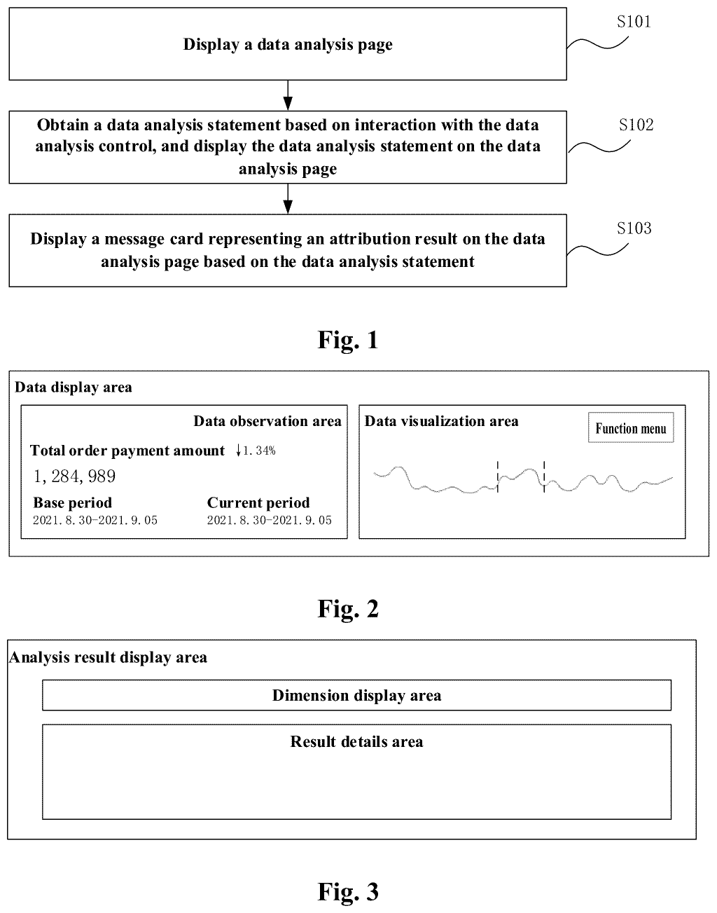

The present embodiment provides a data analysis method, which may be used for the foregoing computer device, such as a tablet computer or a computer. FIG. 1 is a flowchart of a data analysis method according to an embodiment of the present disclosure. As shown in FIG. 1, the process includes the following steps:

Step S101: Display a data analysis page.

The data analysis page includes a data analysis control. The data analysis page may be understood as a page for inputting and executing data attribution analysis. That is, the data analysis page is an externally displayed page of a tool for performing data attribution analysis. The data analysis control is a tool or a component for constructing and executing attribution analysis.

Step S102: Obtain a data analysis statement based on interaction with the data analysis control, and display the data analysis statement on the data analysis page.

To reduce an attribution analysis threshold and facilitate the user to quickly obtain a required attribution result, the data analysis control may be externally displayed in the form of an input box, so that the user can be guided, in a chat form, to use a natural language to input a data analysis statement to be executed here, thereby helping reduce the difficulty of the user in performing attribution analysis on the to-be-attributed data, and making an interaction manner of data query more friendly. For example, the obtained data query statement may be: “Why does the indicator XXX rise/fall during this period of time?”

Step S103: Display a message card representing an attribution result on the data analysis page based on the data analysis statement.

The message card includes a data display area and an analysis result display area. The data display area is configured to display to-be-attributed data corresponding to the data analysis statement, so that the user can clearly view the current to-be-attributed data that is currently waiting for attribution analysis. The analysis result display area is configured to display attribution result details corresponding to the to-be-attributed data, so that the user can more intuitively and quickly understand the result details after the attribution analysis is performed on the to-be-attributed data, so that the user can obtain the attribution result in a more efficient and convenient manner, thereby effectively improving the working efficiency of the user.

The data analysis method provided in this embodiment can directly perform attribution analysis using a data analysis statement obtained from a data analysis page, and display an attribution result through a message card, so that a user can perform attribution analysis on to-be-attributed data more conveniently and more intelligently, thereby helping improve working efficiency of the user in attribution analysis.

In some optional implementations, the data display area comprises a data observation area and a data visualization area, the data observation area is configured to display an observation indicator corresponding to the to-be-attributed data, and the data visualization area is configured to display a target chart representing the observation indicator. By displaying the observation indicator corresponding to the to-be-attributed data in the data observation area, data performance of the indicator at different time points can be clearly described and expressed, providing a basis for subsequent analysis, interpretation, and decision-making. By displaying the target chart in the data visualization area, the user can more intuitively perceive an indicator change trend, and then in combination with the observation indicator displayed in the data observation area, the user can more intuitively and comprehensively perceive a distribution of the to-be-attributed data.

In an example, the observation indicator may include an indicator name, an attribution time range, and base period data and current period data for which data attribution is to be performed under the indicator name, to ensure that the observation data displayed in the data observation area can intuitively understand a growth or decline trend of the observation indicator and a specific numerical difference, thereby providing basic data and a reference basis for subsequent analysis and interpretation. In another example, a chart type corresponding to the target chart is a line chart.

In some optional implementations, the data observation area further comprises a trend observation control, and the trend observation control is configured to display a fluctuation change rate of the observation indicator, thereby facilitating the user to quickly determine a fluctuation rate change of the to-be-attributed data from a base period to a current period. The fluctuation rate change may be a rising percentage or a falling percentage.

In an optional implementation scenario, if the observation indicator corresponding to the to-be-attributed data is “payment order amount”, a schematic diagram of an interface of the data display area may be shown in FIG. 2. The left side of the figure shows the data observation area, and the right side of the figure shows the data visualization area. In the data observation area, the indicator name of the observation indicator is “total order payment amount”; the time range for which data attribution is to be performed is “2021.8.30-2021.9.05”, and the value corresponding to the “total order payment amount” in the base period is “1,284,989”, and the value corresponding to the “total order payment amount” in the current period is “1,184,989”. “1.34%” beside the indicator name is the trend observation control. A waveform chart displayed in the data visualization area is the target chart representing the observation indicator, and a part between the two dotted lines is data of the observation indicator in the time range for which data attribution is to be performed.

In some optional implementations, as shown in FIG. 3, the analysis result display area comprises a dimension display area and a result details area, the dimension display area is configured to display a plurality of dimension controls, and the result details area is configured to display an attribution result of a current attribution dimension.

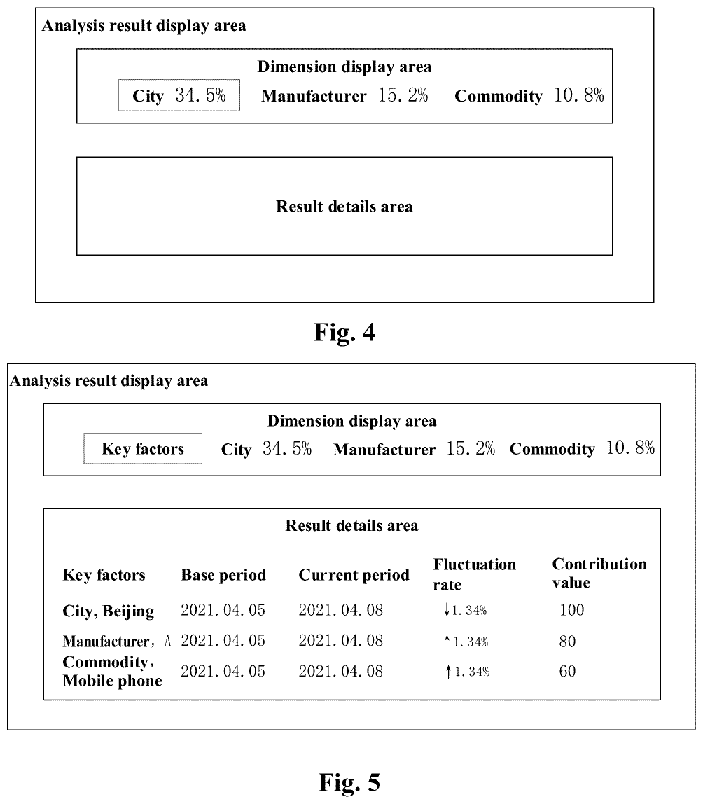

Specifically, to enable the user to obtain the attribution result more intuitively and quickly, the plurality of determined attribution dimensions related to the observation indicator are displayed in the dimension display area in the form of dimension controls, so that the user can quickly determine the plurality of attribution dimensions related to the dimension indicator through the dimension display area. The attribution dimensions comprise corresponding dimension factors and dimension contribution degrees corresponding to the dimension factors, so that the user can quickly understand the influence of each attribution dimension on the observation indicator. For example, as shown in FIG. 4, the observation indicator is “total order payment amount”, and the attribution dimensions related to the observation indicator include a city, a manufacturer, and a commodity. A dimension contribution rate of the city is 34.5%, a dimension contribution rate of the manufacturer is 15.2%, and a dimension contribution rate of the commodity is 10.8%. Therefore, the dimension controls displayed in the dimension display area are “city 34.5%”, “manufacturer 15.2%”, and “commodity 10.8%”, respectively.

To enable the user to more intuitively and fully understand attribution result details corresponding to each attribution dimension and perform targeted data analysis and comparison, an attribution result of an attribution dimension corresponding to the dimension control is displayed based on a currently selected dimension control, so that the user can quickly find a specific attribution result according to his own requirements and interests.

In some optional implementations, the plurality of dimension controls comprise a key factor control and other dimension controls, and the dimension display area is configured to display a plurality of dimension controls, and the method comprises: arranging the key factor at a head place in the dimension display area, and arranging the plurality of dimension controls after the key factor in sequence in descending order of corresponding dimension contribution degrees. The key factor corresponding to the key factor control is a mixed dimension, that is, an attribution result under the key factor can be determined based on the dimension factors under each attribution dimension and the corresponding dimension contribution degrees. Preferably, when the attribution result corresponding to the mixed dimension corresponding to the key factor control is displayed in the result details area, the dimension factors are sorted in descending order of the corresponding dimension contribution degrees, and then a sorting result is displayed in the result details area, so that the user can perceive, from a macroscopic perspective, the dimension factor that has the greatest influence on the attribution of the observation indicator under all the attribution dimensions.

In some optional implementation scenarios, taking the observation indicator “total order payment amount” as an example, the plurality of dimension attribution dimensions are a key factor, a city, a manufacturer, and a commodity, and then an arrangement sequence of the corresponding plurality of dimension controls in the dimension display area may be shown in FIG. 5.

In some optional implementations, the method for displaying a contribution degree of a current attribution dimension in the result details area comprises: determining, in response to an interaction operation on a current dimension control, a current attribution dimension corresponding to the current dimension control; and displaying an attribution result corresponding to the current attribution dimension in the result details area.

That is, the plurality of dimension controls are synchronously displayed in the dimension display area. However, in order to enable the user to quickly and clearly understand the analysis result under each attribution dimension, when the attribution result is displayed in the result details area, the attribution result is determined based on the selected current dimension control, and then the currently displayed attribution result can help the user quickly identify the contribution of each dimension factor and determine a main influence factor under the current attribution dimension, so that the user can clearly understand the influence of each dimension factor on the attribution result, thereby facilitating the user to perform more comprehensive and targeted data insight and quickly locate a problem.

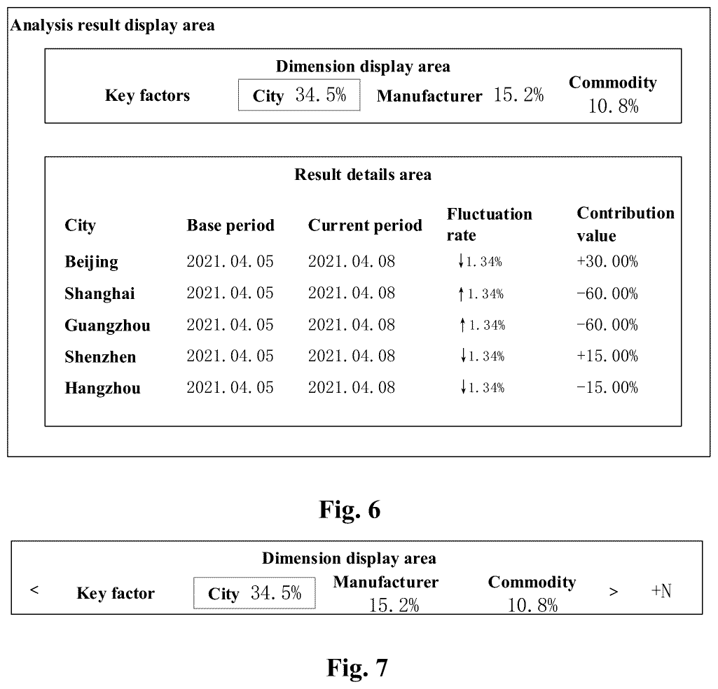

In some optional implementation scenarios, if the current dimension control is the key factor control, the attribution result displayed in the result details area may be shown in FIG. 5. If the current dimension control is the manufacturer control, the attribution result displayed in the result details area may be shown in FIG. 6.

In some optional implementations, the dimension display area further comprises a display switch control. If there are a large number of dimension controls and all the dimension controls cannot be displayed in the dimension display area, the dimension controls currently displayed in the dimension display area may be switched in response to an interaction operation on the display switch control, thereby meeting the requirements of the user for viewing the attribution results under each attribution dimension. For example, as shown in FIG. 7, a style of the display switch control may be a left/right arrow or “+N”, and then the dimension controls currently displayed in the dimension display area can be switched by responding to clicking on the left/right arrow or clicking on “+N” to call a drop-down menu.

In some optional implementations, the displaying an attribution result corresponding to the current attribution dimension in the result details area comprises:

step a1, determining a plurality of dimension values related to the observation indicator in the current attribution dimension;

step a2, separately determining a contribution degree corresponding to each dimension value;

step a3, sorting the plurality of dimension values based on the corresponding contribution degrees to obtain a sorting result; and

step a4, using the sorting result as the attribution result corresponding to the current attribution dimension, and displaying the attribution result in the result details area.

Specifically, to enable the user to quickly perceive the influence of each of the plurality of dimension values related to the observation indicator in the current attribution dimension on the attribution result, the contribution degree corresponding to each dimension value is separately determined, and then the plurality of dimension values are sorted based on the corresponding contribution degrees, and the obtained sorting result is used as the attribution result and displayed in the result details area. Therefore, when the user views the result details area, a potential problem or an optimization strategy can be found, thereby facilitating the user to make better improvements.

For example, as shown in FIG. 6, if the current attribution dimension is a city, the plurality of dimension values related to the observation indicator may be Beijing, Shanghai, Guangzhou, Hangzhou, Shenzhen, etc., respectively. The dimension values can be arranged in descending order of the contribution degrees, and then the sorting result is displayed in the result details area, which helps the user focus on the dimension value with the greatest contribution, thereby facilitating subsequent targeted improvement and optimization.

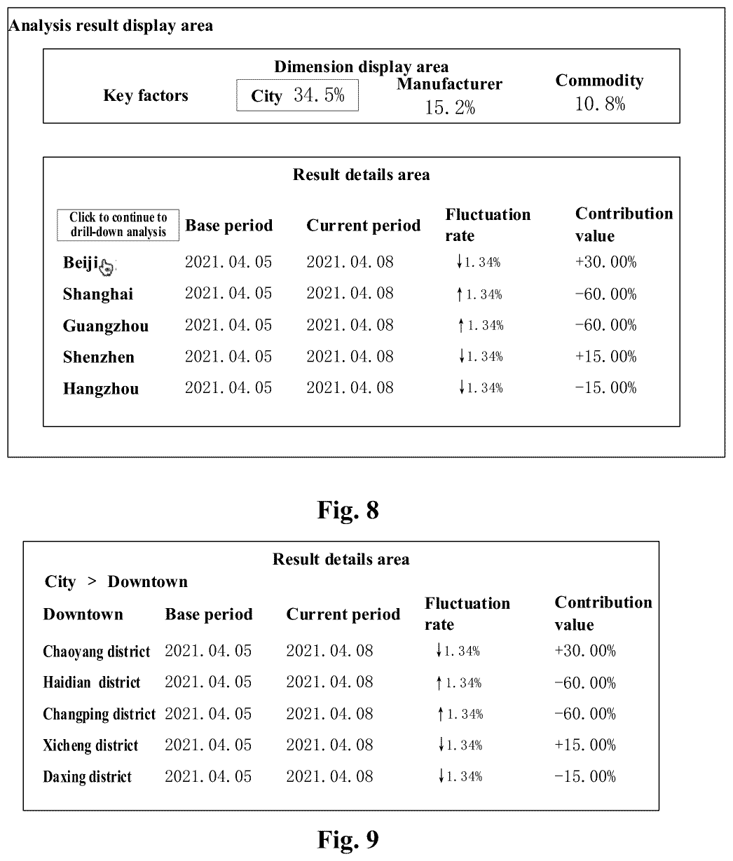

In some optional implementations, the method further comprises: identifying a dimension value to be selected in a current result details area; if there are a plurality of drill-down dimensions in the dimension value to be selected, displaying a drill-down analysis prompt; and in response to the dimension value to be selected being selected, displaying an attribution details page corresponding to the plurality of drill-down dimensions. That is, it may be understood as that under the current attribution dimension, some dimension values have drill-down dimensions. When it is identified that there are a plurality of drill-down dimensions in the dimension value to be selected, the drill-down analysis prompt shown in FIG. 8 is displayed: “Click to continue drill-down analysis”, to prompt the user that there are drill-down dimensions in the dimension value to be selected, thereby guiding the user to continue targeted viewing. In an example, the dimension value to be selected may be determined based on a position of a cursor hover (Hover). In another example, the drill-down analysis prompt may be prompted through a tooltip (Tooltips). A style of the tooltip is not limited to a pop-up window.

After the user selects the dimension value to be selected, the attribution details page corresponding to the plurality of drill-down dimensions is called and displayed, so that the user can understand the influence of each drill-down dimension on the attribution result.

For example, as shown in FIG. 7, the dimension value to be selected is “Beijing”, and “Beijing” has a plurality of drill-down dimensions, and then in response to “Beijing” being selected, the attribution details page shown in FIG. 9 is displayed.

In other optional implementations, after entering the attribution details page, the current result details area can be returned to through breadcrumb navigation, thereby making the manner in which the user queries the attribution result simpler and more convenient, and facilitating flexible operation by the user.

In addition, attribution analysis is performed in this manner, and there is no need to preset an embedded point for a data analysis problem in advance, so that the obtained attribution result can reduce human intervention, which can make the obtained attribution result more objective, and also help reduce dimension costs and enhance scalability.

In some optional implementations, the result details area further comprises a display of a fluctuation rate corresponding to the dimension value, thereby ensuring that the displayed attribution result is more comprehensive.

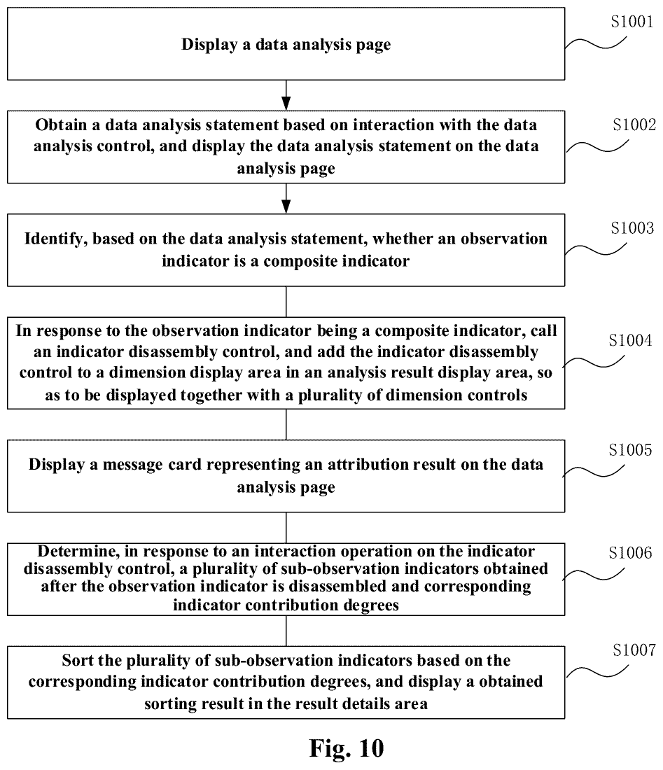

The present embodiment provides a data analysis method, which may be used for the foregoing computer device, such as a tablet computer or a computer. FIG. 10 is a flowchart of a data analysis method according to an embodiment of the present disclosure. As shown in FIG. 10, the process includes the following steps:

Step S1001: Display a data analysis page.

Step S1002: Obtain a data analysis statement based on interaction with the data analysis control, and display the data analysis statement on the data analysis page.

Step S1003: Identify, based on the data analysis statement, whether an observation indicator is a composite indicator.

The observation indicator involved in the data analysis statement may be a single indicator or a composite indicator. However, since the composite indicator includes comprehensive information of a plurality of sub-observation indicators, if attribution analysis is directly performed using the composite indicator, it is not easy to distinguish an independent contribution of each indicator, thereby affecting the effectiveness of an attribution result.

Therefore, before performing attribution analysis, it is first identified whether the observation indicator is a composite indicator, to determine whether attribution analysis can be directly performed.

Step S1004: If the observation indicator is a composite indicator, call an indicator disassembly control, and add the indicator disassembly control to a dimension display area in an analysis result display area, so as to be displayed together with a plurality of dimension controls.

If the observation indicator is a composite indicator, the indicator disassembly control is called, and the indicator disassembly control is added to the dimension display area in the analysis result display area, to inform the user that the observation indicator is a composite indicator, and indicator disassembly processing needs to be performed on the observation indicator, to ensure the effectiveness and reliability of attribution analysis.

Step S1005: Display a message card representing an attribution result on the data analysis page.

The data analysis method provided in this embodiment enables the user to clearly understand a composite situation of an observed value indicator through the message card displayed on the data analysis page, thereby facilitating the user to understand the to-be-attributed data in many aspects, thereby improving working efficiency.

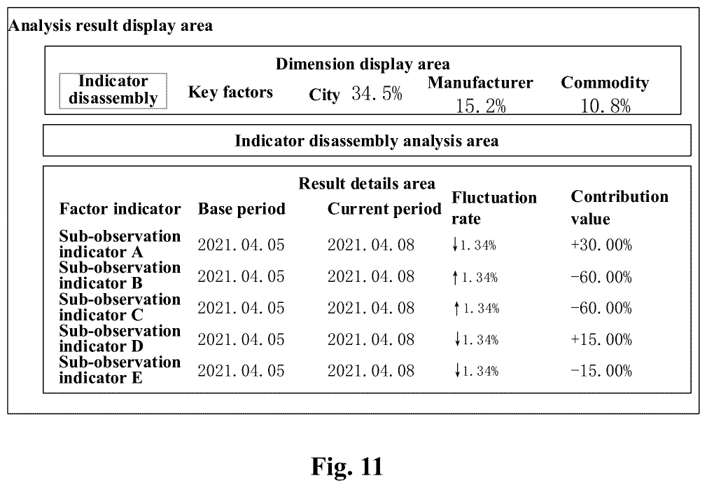

In some optional implementations, as shown in FIG. 11, the analysis result display area further comprises an indicator disassembly analysis area, the indicator disassembly analysis area is configured to display a disassembly formula of the observation indicator, so that the user can clearly understand the composition and calculation method of the composite indicator through the disassembly formula, thereby facilitating generating a more accurate and explainable attribution result, and ensuring the effectiveness and reliability of attribution analysis.

Further, the foregoing data analysis method further comprises:

Step S1006: Determine, in response to an interaction operation on the indicator disassembly control, a plurality of sub-observation indicators obtained after the observation indicator is disassembled and corresponding indicator contribution degrees.

To facilitate the user to determine a sub-observation indicator that has the greatest influence on the observation indicator from the plurality of sub-observation indicators, the indicator contribution degree of each sub-observation indicator is separately determined.

Step S1007: Sort the plurality of sub-observation indicators based on the corresponding indicator contribution degrees, and display a sorting result in the result details area.

The sub-observation indicators are sorted in descending order of the indicator contribution degrees, and the obtained sorting result is displayed in the result details area, so that the user can quickly locate the sub-observation indicator that has the greatest influence on the attribution result, thereby facilitating the user to subsequently perform targeted analysis on the sub-observation indicator. In an optional implementation scenario, the sorting result of the plurality of sub-observation indicators may be shown in FIG. 11.

The data analysis method provided in this embodiment can support performing contribution degree attribution by disassembling according to a calculation formula of a composite indicator, can eliminate interference between different sub-observation dimensions, and can make the obtained attribution result more objective and effective, thereby helping improve the working efficiency of the user in attribution analysis.

In some optional implementations, the message card further comprises a function recommendation area, the function recommendation area is configured to display a data summary control, and the data analysis method further comprises: generating and displaying summary text of the attribution result in response to an interaction operation on the data summary control. To improve the efficiency of the user in reading the attribution result, the data summary control is further provided on the displayed message card, so that when the user performs an interaction operation on the data summary control, intelligent analysis can be performed on the attribution result, and the summary text of the attribution result is generated and displayed, thereby facilitating the user to quickly understand core content of the attribution result through the generated summary text.

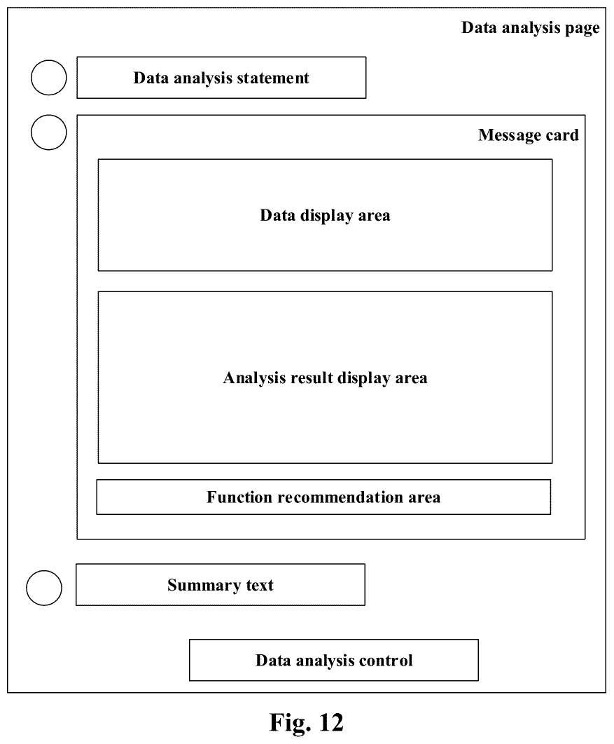

In an optional implementation scenario, as shown in FIG. 12, the generated summary text may be located below the message card.

In some optional implementations, the data display area comprises a plurality of function operation controls, and the data analysis method further comprises: performing, in response to an interaction operation on a target function operation control, an operation function corresponding to the target function operation control; and the target function operation control is a selected function operation control. The operation function includes but is not limited to any of the following functions: refreshing, collection, sharing, or full-screen mode. The refreshing can ensure data timeliness, and facilitate the user to refresh data when a page stay time is too long. The collection helps perform data tracking and monitoring in a later period, and there is no need to repeatedly ask and obtain. The full-screen mode is used to display the obtained target chart in full screen, thereby facilitating the user to view data details.

In some optional implementations, the data display area shown in FIG. 2 further comprises a function menu; the plurality of function operation controls comprise a first function operation control and a second function operation control, the first function operation control is directly displayed in the data display area, and the second function operation control is hidden in the function menu; and the method further comprises: displaying the second function operation control in response to an interaction operation on the function menu. That is, due to different screen display sizes of computer devices, display areas of the data display area may also be different. To ensure the integrity of the function and avoid excessive occupation of the display area of the data display area, some function operation controls may be hidden in the function menu, and then when the user needs to perform the second function operation control hidden in the function menu, the user can perform an interaction operation on the function menu to obtain the required second function operation control from the expanded function menu.

In some optional implementations, the data analysis page further comprises a configuration menu, and the method further comprises: displaying a display attribute details page of the message card in response to an interaction operation on the configuration menu, wherein the display attribute details page is used to adjust display content of the message card. By displaying the attribute details page, the user can quickly understand the display content of the message card, and then perform targeted configuration, so that the content displayed on the message card better meets the personalized requirements of the user.

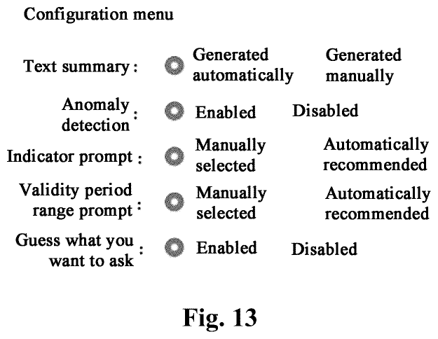

In an optional implementation scenario, as shown in FIG. 13, the attribute details page may include the following configuration content: whether to actively generate text summary, whether to enable anomaly detection, whether to recommend an indicator prompt, whether to prompt a validity period range, and whether to enable guess what you want to ask.

As one or more specific application embodiments of the embodiments of the present disclosure, when the user needs to perform attribution analysis on the to-be-attributed data, the user inputs a data analysis statement to be subjected to the attribution analysis through a data query control on the displayed data analysis page.

The data analysis statement is obtained based on interaction with the data analysis control, the data analysis statement is displayed on the data analysis page, and an obtained analysis result is displayed through a message card, thereby ensuring that a non-professional can quickly complete a required attribution analysis task, and the interaction is simple and the learning cost is low.

In addition, during attribution analysis, there is no need to first assume an attribution reason, all dimension factors are automatically displayed, and a factor with a high contribution degree is placed at the top, so that the user can efficiently obtain information, thereby facilitating the user to perceive, from a macroscopic perspective, the dimension factor that has the greatest influence on the attribution of the observation indicator under all the attribution dimensions, thereby facilitating targeted positioning and improving attribution efficiency.

Further, the data analysis method provided in the present disclosure supports a plurality of attribution dimensions and dimension drills, thereby helping the user to continuously narrow the problem range and improve positioning accuracy.

The present embodiment further provides a data analysis apparatus, which is configured to implement the foregoing embodiments and preferred implementations, and which will not be described again if it has been described. As used below, the term “module” may be a combination of software and/or hardware that implements a predetermined function. Although the apparatus described in the following embodiments is preferably implemented in software, implementation in the form of hardware, or a combination of software and hardware, is also possible and contemplated.

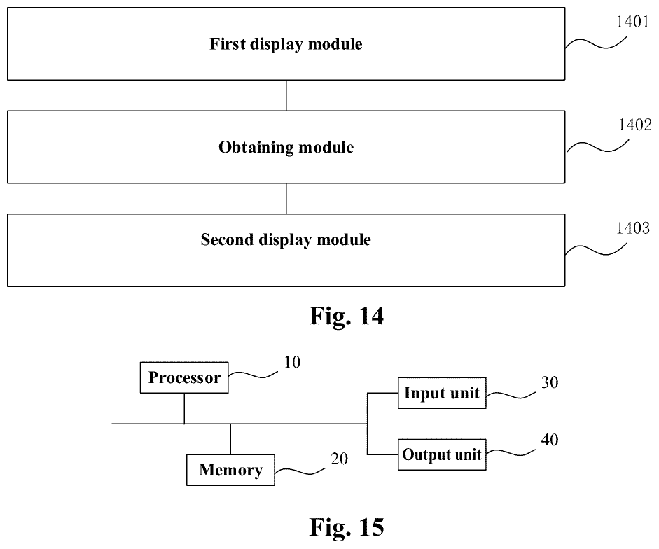

The present embodiment provides a data analysis apparatus. As shown in FIG. 14, the apparatus comprises:
a first display module 1401, configured to display a data analysis page, where the data analysis page comprises a data analysis control;
an obtaining module 1402, configured to obtain a data analysis statement based on interaction with the data analysis control, and display the data analysis statement on the data analysis page; and
a second display module 1403, configured to display a message card representing an attribution result on the data analysis page based on the data analysis statement, where the message card comprises a data display area and an analysis result display area, the data display area is configured to display to-be-attributed data corresponding to the data analysis statement, and the analysis result display area is configured to display attribution result details corresponding to the to-be-attributed data.

In some optional implementations, the data display area comprises a data observation area and a data visualization area, the data observation area is configured to display an observation indicator corresponding to the to-be-attributed data; and the data visualization area is configured to display a target chart representing the observation indicator.

In some optional implementations, the data observation area further comprises a trend observation control, and the trend observation control is configured to display a fluctuation change rate of the observation indicator.

In some optional implementations, the analysis result display area comprises a dimension display area and a result details area, the dimension display area is configured to display a plurality of dimension controls, different dimension controls correspond to different attribution dimensions related to the observation indicator, the attribution dimensions comprise corresponding dimension factors and dimension contribution degrees corresponding to the dimension factors, and the result details area is configured to display an attribution result of a current attribution dimension.

In some optional implementations, the plurality of dimension controls comprise a key factor control and other dimension controls, and the dimension display area is configured to display a plurality of dimension controls, and the method comprises:
arranging the key factor at a head place in the dimension display area, and arranging the plurality of dimension controls after the key factor in sequence in descending order of corresponding dimension contribution degrees.

In some optional implementations, the apparatus for displaying a contribution degree of a current attribution dimension in the result details area comprises:
a first processing module, configured to determine, in response to an interaction operation on a current dimension control, a current attribution dimension corresponding to the current dimension control; and
a third display module, configured to display an attribution result corresponding to the current attribution dimension in the result details area.

In some optional implementations, the third display module comprises:
a first determination unit, configured to determine a plurality of dimension values related to the observation indicator in the current attribution dimension;
a second determination unit, configured to separately determine a contribution degree corresponding to each dimension value;
a first execution unit, configured to sort the plurality of dimension values based on the corresponding contribution degrees to obtain a sorting result; and
a second execution unit, configured to use the sorting result as the attribution result corresponding to the current attribution dimension, and display the attribution result in the result details area.

In some optional implementations, the apparatus further comprises:
a first identification module, configured to identify a dimension value to be selected in a current result details area;
a fourth display module, configured to display a drill-down analysis prompt if there are a plurality of drill-down dimensions in the dimension value to be selected; and
a fifth display module, configured to display an attribution details page corresponding to the plurality of drill-down dimensions in response to the dimension value to be selected being selected.

In some optional implementations, the result details area further comprises a display of a fluctuation rate corresponding to the dimension value.

In some optional implementations, before the message card representing the attribution result is displayed on the data analysis page, the apparatus further comprises:
a second identification module, configured to identify whether the observation indicator is a composite indicator; and
a second processing module, configured to call an indicator disassembly control and add the indicator disassembly control to the dimension display area if the observation indicator is a composite indicator, so as to be displayed together with the plurality of dimension controls.

In some optional implementations, the analysis result display area further comprises an indicator disassembly analysis area, the indicator disassembly analysis area is configured to display a disassembly formula of the observation indicator, and the apparatus further comprises:
a third execution module, configured to determine, in response to an interaction operation on the indicator disassembly control, a plurality of sub-observation indicators obtained after the observation indicator is disassembled and corresponding indicator contribution degrees; and
a fourth execution module, configured to sort the plurality of sub-observation indicators based on the corresponding indicator contribution degrees, and display a sorting result in the result details area.

In some optional implementations, the message card further comprises a function recommendation area, the function recommendation area is configured to display a data summary control, and the apparatus further comprises:
a third processing module, configured to generate and display summary text of the attribution result in response to an interaction operation on the data summary control.

In some optional implementations, the data display area comprises a plurality of function operation controls, and the apparatus further comprises:
a fourth processing module, configured to perform, in response to an interaction operation on a target function operation control, an operation function corresponding to the target function operation control;
the target function operation control is a selected function operation control.

In some optional implementations, the data display area further comprises a function menu; the plurality of function operation controls comprise a first function operation control and a second function operation control, the first function operation control is directly displayed in the data display area, and the second function operation control is hidden in the function menu; and
the apparatus further comprises:
a fifth processing module, configured to display the second function operation control in response to an interaction operation on the function menu.

In some optional implementations, the data analysis page further comprises a configuration menu, and the apparatus further comprises:
a sixth processing module, configured to display a display attribute details page of the message card in response to an interaction operation on the configuration menu, wherein the display attribute details page is used to adjust display content of the message card.

Further functional descriptions of the foregoing modules and units are the same as those of the corresponding embodiments, and are not described herein again.

The data analysis apparatus in this embodiment is presented in the form of a functional unit. The unit herein refers to an ASIC (Application Specific Integrated Circuit) circuit, a processor and a memory that execute one or more software or firmware programs, and/or other devices that can provide the foregoing functions.

An embodiment of the present disclosure further provides a computer device, which has the data analysis apparatus shown in FIG. 14.

Please refer to FIG. 15, which is a schematic diagram of a structure of a computer device according to an optional embodiment of the present disclosure. As shown in FIG. 15, the computer device includes one or more processors 10, a memory 20, and an interface for connecting various components, including a high-speed interface and a low-speed interface. The various components are connected to each other through different buses and can be installed on a common main board or installed in another manner as required. The processor may process instructions executed in the computer device, including instructions stored in the memory or on the memory to display graphical information of a GUI on an external input/output apparatus (such as a display device coupled to the interface). In some optional implementations, if necessary, a plurality of processors and/or a plurality of buses may be used together with a plurality of memories and a plurality of memories. Similarly, a plurality of computer devices may be connected, and each device provides some necessary operations (for example, as a server array, a group of blade servers, or a multi-processor system). FIG. 15 shows an example of one processor 10.

The processor 10 may be a central processor, a network processor, or a combination thereof. The processor 10 may further include a hardware chip. The hardware chip may be an ASIC (Application Specific Integrated Circuit), a programmable logic device, or a combination thereof. The programmable logic device may be a complex programmable logic device, a field programmable gate array, a general array logic, or any combination thereof.

The memory 20 is stored with instructions executable by at least one processor 10, so that the at least one processor 10 executes the method shown in the foregoing embodiment.

The memory 20 may include a program storage area and a data storage area. The program storage area may store an operating system and an application program required by at least one function. The data storage area may store data created according to the use of the computer device. In addition, the memory 20 may include a high-speed random access memory, and may further include a non-transitory memory, for example, at least one magnetic disk storage device, a flash memory device, or another non-transitory solid-state storage device. In some optional implementations, the memory 20 may optionally include a memory remotely arranged relative to the processor 10, and the remote memory may be connected to the computer device through a network. Examples of the foregoing network include, but are not limited to, the Internet, an intranet, a local area network, a mobile communication network, and a combination thereof.

The memory 20 may include a volatile memory, for example, a random access memory; the memory may further include a non-volatile memory, for example, a flash memory, a hard disk, or a solid-state hard disk; and the memory 20 may further include a combination of the foregoing types of memories.

The computer device further includes an input unit 30 and an output unit 40. The processor 10, the memory 20, the input unit 30, and the output unit 40 may be connected through a bus or in another manner. In FIG. 13, connection through a bus is used as an example.

The input unit 30 may receive inputted numeric or character information, and generate a key signal input related to user settings and function control of the computer device, for example, a touch screen, a keypad, a mouse, a trackpad, a touchpad, an indicator, one or more mouse buttons, a trackball, a joystick, and the like. The output unit 40 may include a display device, an auxiliary lighting apparatus (for example, an LED), a haptic feedback apparatus (for example, a vibration motor), and the like. The display device includes, but is not limited to, a liquid crystal display, a light-emitting diode display, a plasma display, and the like. In some optional implementations, the display device may be a touch screen.

An embodiment of the present disclosure further provides a computer-readable storage medium. The method according to the embodiment of the present disclosure may be implemented in hardware or firmware, or may be implemented as computer code that can be recorded in a storage medium, or may be implemented as original computer code that is stored in a remote storage medium or a non-transitory machine-readable storage medium and downloaded through a network and then stored in a local storage medium, so that the method described herein can be stored in such software processing on a storage medium using a general-purpose computer, a dedicated processor, or programmable or dedicated hardware. The storage medium may be a magnetic disk, an optical disc, a read-only memory, a random access memory, a flash memory, a hard disk, a solid-state hard disk, or the like. Further, the storage medium may further include a combination of the foregoing types of memories. It may be understood that a computer, a processor, a microprocessor controller, or programmable hardware includes a storage component that can store or receive software or computer code. When the software or computer code is accessed and executed by the computer, the processor, or the hardware, the method shown in the foregoing embodiment is implemented.

It may be understood that before the technical solutions disclosed in the embodiments of the present disclosure are used, the user shall be informed of the type, the use scope, the use scenario, and the like of the personal information involved in the present disclosure and obtain the user's authorization in an appropriate manner based on relevant laws and regulations.

For example, prompt information is sent to the user in response to receiving an active request from the user, to explicitly prompt the user that an operation requested by the user will need to acquire and use the user's personal information. Therefore, the user can independently choose whether to provide the personal information to software or hardware, such as an electronic device, an application, a server, or a storage medium, that executes an operation of the technical solution of the present disclosure based on the prompt information.

As an optional but non-restrictive implementation, for example, the prompt information may be sent to the user in a pop-up window in response to receiving the active request from the user. The prompt information may be presented in the pop-up window in a text manner. In addition, selection controls for allowing the user to select to “agree” or “disagree” to provide the personal information to the electronic device may also be carried in the pop-up window.

It may be understood that the foregoing process of notifying and obtaining the user's authorization is merely illustrative and does not constitute a limitation to the implementation of the present disclosure. Other manners that meet relevant laws and regulations may also be applied to the implementation of the present disclosure.

Although the embodiments of the present disclosure are described with reference to the accompanying drawings, various modifications and variations can be made by those skilled in the art without departing from the spirit and scope of the present disclosure, and such modifications and variations all fall within the scope defined by the appended claims.

I/We claim:

1. A data analysis method, comprising:
displaying a data analysis page, wherein the data analysis page comprises a data analysis control;
obtaining a data analysis statement based on interaction with the data analysis control, and displaying the data analysis statement on the data analysis page; and
displaying a message card representing an attribution result on the data analysis page based on the data analysis statement, wherein the message card comprises a data display area and an analysis result display area, the data display area is configured to display to-be-attributed data corresponding to the data analysis statement, and the analysis result display area is configured to display attribution result details corresponding to the to-be-attributed data.

2. The method according to claim 1, wherein the data display area comprises a data observation area and a data visualization area, the data observation area is configured to display an observation indicator corresponding to the to-be-attributed data, and the data visualization area is configured to display a target chart representing the observation indicator.

3. The method according to claim 2, wherein the data observation area further comprises a trend observation control, and the trend observation control is configured to display a fluctuation change rate of the observation indicator.

4. The method according to claim 2, wherein the analysis result display area comprises a dimension display area and a result details area, the dimension display area is configured to display a plurality of dimension controls, different dimension controls correspond to different attribution dimensions related to the observation indicator, the attribution dimensions comprise corresponding dimension factors and dimension contribution degrees corresponding to the dimension factors, and the result details area is configured to display an attribution result of a current attribution dimension.

5. The method according to claim 4, wherein the plurality of dimension controls comprise a key factor control and other dimension controls, and the dimension display area is configured to display a plurality of dimension controls, and the method comprises:
arranging the key factor at a head place in the dimension display area, and arranging the plurality of dimension controls after the key factor in sequence in a descending order of corresponding dimension contribution degrees.

6. The method according to claim 4, wherein the method for displaying a contribution degree of a current attribution dimension in the result details area comprises:
in response to an interaction operation on a current dimension control, determining a current attribution dimension corresponding to the current dimension control; and
displaying an attribution result corresponding to the current attribution dimension in the result details area.

7. The method according to claim 6, wherein the displaying an attribution result corresponding to the current attribution dimension in the result details area comprises:
determining a plurality of dimension values related to the observation indicator in the current attribution dimension;
separately determining a contribution degree corresponding to each dimension value;
sorting the plurality of dimension values based on the corresponding contribution degrees to obtain a sorting result; and
using the sorting result as the attribution result corresponding to the current attribution dimension, and displaying the attribution result in the result details area.

8. The method according to claim 7, wherein the method further comprises:
identifying a dimension value to be selected in a current result details area;
in response to there being a plurality of drill-down dimensions in the dimension value to be selected, displaying a drill-down analysis prompt; and
in response to the dimension value to be selected being selected, displaying an attribution details page corresponding to the plurality of drill-down dimensions.

9. The method according to claim 8, wherein the result details area further comprises a display of a fluctuation rate corresponding to the dimension value.

10. The method according to claim 4, wherein before the displaying a message card representing an attribution result on the data analysis page, the method further comprises:
identifying whether the observation indicator is a composite indicator; and
in response to the observation indicator being a composite indicator, calling an indicator disassembly control, and adding the indicator disassembly control to the dimension display area, so as to be displayed together with the plurality of dimension controls.

11. The method according to claim 10, wherein the analysis result display area further comprises an indicator disassembly analysis area, the indicator disassembly analysis area is configured to display a disassembly formula of the observation indicator, and the method further comprises:
in response to an interaction operation on the indicator disassembly control, determining a plurality of sub-observation indicators obtained after the observation indicator is disassembled and corresponding indicator contribution degrees; and
sorting the plurality of sub-observation indicators based on the corresponding indicator contribution degrees, and displaying a sorting result in the result details area.

12. The method according to claim 1, wherein the message card further comprises a function recommendation area, the function recommendation area is configured to display a data summary control, and the method further comprises:
generating and displaying summary text of the attribution result in response to an interaction operation on the data summary control.

13. The method according to claim 1, wherein the data display area comprises a plurality of function operation controls, and the method further comprises:
in response to an interaction operation on a target function operation control, performing an operation function corresponding to the target function operation control; and
wherein the target function operation control is a selected function operation control.

14. The method according to claim 13, wherein the data display area further comprises a function menu; the plurality of function operation controls comprise a first function operation control and a second function operation control, the first function operation control is directly displayed in the data display area, and the second function operation control is hidden in the function menu; and
the method further comprises:
displaying the second function operation control in response to an interaction operation on the function menu.

15. The method according to claim 1, wherein the data analysis page further comprises a configuration menu, and the method further comprises:
displaying a display attribute details page of the message card in response to an interaction operation on the configuration menu, wherein the display attribute details page is used to adjust display content of the message card.

16. A computer device, comprising:
a memory and a processor, wherein the memory and the processor are communicatively connected to each other, the memory stores computer instructions, and the processor executes the computer instructions, thereby performing the data analysis method comprising:
displaying a data analysis page, wherein the data analysis page comprises a data analysis control;
obtaining a data analysis statement based on interaction with the data analysis control, and displaying the data analysis statement on the data analysis page; and
displaying a message card representing an attribution result on the data analysis page based on the data analysis statement, wherein the message card comprises a data display area and an analysis result display area, the data display area is configured to display to-be-attributed data corresponding to the data analysis statement, and the analysis result display area is configured to display attribution result details corresponding to the to-be-attributed data.

17. The computer device according to claim 16, wherein the data display area comprises a data observation area and a data visualization area, the data observation area is configured to display an observation indicator corresponding to the to-be-attributed data, and the data visualization area is configured to display a target chart representing the observation indicator.

18. The computer device according to claim 17, wherein the data observation area further comprises a trend observation control, and the trend observation control is configured to display a fluctuation change rate of the observation indicator.

19. The computer device according to claim 17, wherein the analysis result display area comprises a dimension display area and a result details area, the dimension display area is configured to display a plurality of dimension controls, different dimension controls correspond to different attribution dimensions related to the observation indicator, the attribution dimensions comprise corresponding dimension factors and dimension contribution degrees corresponding to the dimension factors, and the result details area is configured to display an attribution result of a current attribution dimension.

20. A non-transitory computer-readable storage medium having computer instructions stored thereon, and the computer instructions are used to cause a computer to perform the data analysis method comprising:
displaying a data analysis page, wherein the data analysis page comprises a data analysis control;
obtaining a data analysis statement based on interaction with the data analysis control, and displaying the data analysis statement on the data analysis page; and
displaying a message card representing an attribution result on the data analysis page based on the data analysis statement, wherein the message card comprises a data display area and an analysis result display area, the data display area is configured to display to-be-attributed data corresponding to the data analysis statement, and the analysis result display area is configured to display attribution result details corresponding to the to-be-attributed data.
